(19) United States
(12) Patent Application Publication
(10) Pub. No.: US 2008/0036205 A1
(43) Pub. Date: Feb. 14, 2008

(54) Piping joint

(75) Inventors: Fumio Kojima, Nagoya-shi (JP); Morito Oshita, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/882,108

(22) Filed: Jul. 30, 2007

(30) Foreign Application Priority Data
Aug. 10, 2006 (JP) 2006-218596

(51) Int. Cl. F16L 37/12

(52) U.S. Cl. 285/319

(57) ABSTRACT

A piping joint includes: a joint body; a tube inserted into the joint body; a retaining member mounted inside the joint body and located at a distance from an opening of the joint body, the retaining member supporting the tube inserted into the joint body; a guiding member having a guiding portion inserted into the joint body and engagement portions, the guiding portion guiding the tube so as to prevent the tube from vibrating in a radial direction of the joint body, the engagement portions elastically deformable relative to the guiding portion; and a restraining member mounted to the guiding member and restraining an elastic deformation of the engagement portions relative to the guiding portion.

### CROSS REFERENCE TO RELATED APPLICATIONS

This application is based on and claims priority under 35 U.S.C. §119 to Japanese Patent Application 2006-218596, filed on Aug. 10, 2006, the entire content of which is incorporated herein by reference.

### FIELD OF THE INVENTION

The present invention relates to a piping joint to be applied to various pipe arrangements for example for use in a vehicle.

### BACKGROUND

A known piping joint is described in JP 2001-74185A, which discloses a piping joint for connecting a hollow cylindrical body of the piping joint (hereinafter, referred to as a joint-body pipe) to a tube by inserting the tube into a passage formed inside the joint-body pipe. The piping joint includes a retaining member to be mounted inside the joint body at a position away from an opening of the joint body so as to retain the tube and a guiding member detachably provided on the joint body. The guiding member is used for restraining vibrations of the tube with respect to the retaining member. The guiding member includes a guiding portion inserted into the opening of the joint body and occupying a space between an inner peripheral surface of the joint body and an outer peripheral surface of the tube. The guiding portion supports the joint body so as not to vibrate in a radial direction. The guiding member further includes engagement portions which are configured to elastically deform against the guiding portion and is engaged with the outer peripheral surface of the joint body. The guiding member is detached from the joint body when the engagement portions are elastically deformed with respect to the guiding portion.

However, according to the above-mentioned piping joint, when the guiding member is detached from the joint body due to elastic deformation of the engagement portions with respect to the guiding portion resulting from any cause, the vibrations of the tube with respect to the retaining member may not be restrained. When this vibration degree exceeds an allowable range, load, which corresponds to a force for supporting the tube at the retaining member, may decrease. In the light of foregoing, recent attention has been focused on enhancing reliability relating to a connection between the joint body and the tube.

Especially, in environments where the joint body widely moves with respect to the tube (in a portion where the tube is connected and supported), when the guiding member is detached from the joint body, large force acts between the tube and the retaining member. Accordingly, recent attention has been focused on ensuring reliability relating to the connection between the joint body and the tube.

A need thus exists for a piping joint which is not susceptible to the drawback mentioned above.

### SUMMARY OF THE INVENTION

According to an aspect of the present invention, a piping joint includes: a joint body being a hollow shape and formed with a passage; a tube inserted into the joint body through the passage; a retaining member mounted inside the joint body and located at a distance from an opening of the joint body, the retaining member supporting the tube inserted into the joint body; a guiding member having a guiding portion and engagement portions. The guiding portion is inserted into the joint body through the opening and is arranged between an inner peripheral surface of the joint body and an outer peripheral surface of the tube. The guiding portion guides the tube so as to prevent the tube from vibrating in a radial direction of the joint body. The engagement portions is elastically deformable relative to the guiding portion and engageable with an outer peripheral surface of the joint member, wherein the guiding member is detached from the joint body when the engagement portions are elastically deformed with respect to the guiding portion. The piping joint further includes a restraining member mounted to the guiding member and restraining an elastic deformation of the engagement portions relative to the guiding portion.

### BRIEF DESCRIPTION OF THE DRAWINGS

The foregoing and additional features and characteristics of the present invention will become more apparent from the following detailed description considered with reference to the accompanying drawings, wherein:

FIG. 1 is an axial cross-section view of a piping joint according to an embodiment of the present invention;

FIG. 2 is a top view of a condition of a guiding member engaged with a joint body;

FIG. 3 is a partial cross-section view of a tube;

FIG. 4 is a left side view of the guiding member shown in FIG. 1;

FIG. 5 is a partly cross-section view taken from above of the guiding member shown in FIG. 1;

FIG. 6 is a front view of the guiding member shown in FIG. 1;

FIG. 7 is a view illustrating a positional relation between a holder and the guiding member;

FIG. 8 is a top view of the holder shown in FIG. 7;

FIG. 9 is a view illustrating a condition where the holder is mounted on the guiding member 50;

FIG. 10 is a view illustrating a condition where the guiding member is integrated with the holder 60;

FIG. 11 is a view illustrating a positional relation between a holder and the guiding member;

FIG. 12 is a top view of the holder shown in FIG. 11;

FIG. 13 is a view illustrating a condition where the holder is mounted on the guiding member; and

FIG. 14 is a view illustrating a condition where the guiding member is integrated with the holder.

### DETAILED DESCRIPTION

An embodiment of the present invention will be explained with reference to the illustrations of the drawing figures as follows.

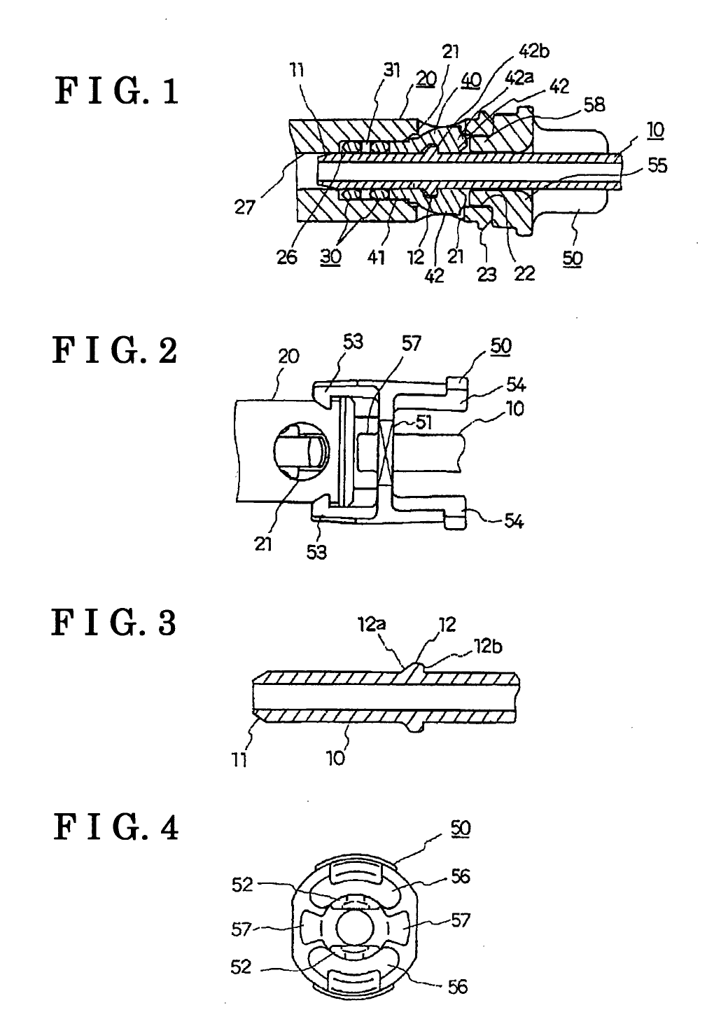

FIG. 1 is an axial cross-section view of a piping joint according to the embodiment of the present invention. This piping joint mainly includes a joint body 20 accommodating a tube 10, O-rings 30, 30 each serving as a sealing member and accommodated in the joint body 20, a retaining member 40 accommodated in the joint body 20 and retaining the tube 10 and O-rings 30, 30 in the joint body 20, and a guiding member 50 detachably provided on the joint body 20, thereby connecting the tube 10 to the joint body 20 by inserting the tube 10 into a passage 27 of the joint body 20.

As illustrated in FIG. 1 and FIG. 3, the tube 10 forms a hollow cylindrical shape and includes an inclined portion 11 which is formed to be tapered and inclined at an edge of the tube 10. Moreover, an annular projection 12 is formed on the outer peripheral surface of the tube 10 at a specified distance from an end of the tube 10. The annular projection 12 includes a gradual inclined surface 12a at the front thereof (left side in FIG. 1) and also a vertical surface 12b at the rear (right side in FIG. 1) thereof. The vertical surface 12b is provided perpendicular to the outer peripheral surface of the tube 10.

The joint body 20 is provided with the passage 27 that overlaps a part of a connection area of the tube 10. The joint body 20 is formed from synthetic resin or metal depending on material of the connection area of the tube 10. As shown in FIG. 1, a pair of upper and lower pass-through windows 21, 21 are circumferentially formed on the joint body 20 at a specified distance from the opening of the joint body 20 through which the tube 10 is inserted. Moreover, a flange 23 is formed on the outer periphery of the opening edge of the joint body 20.

Inner peripheral surfaces 26, 27 of the joint body 20 are formed at two stages. An inner diameter of the inner peripheral surface 27 is established approximately equal to an outer diameter of the tube 10 while an inner diameter of the inner peripheral surface 26 is larger than the inner diameter of the inner peripheral surface 27.

As illustrated in FIG. 1, the O-rings 30, 30 are mounted on the inner peripheral surface 26 of the joint body 20. A support ring 31 is placed between both of the O-rings 30, 30.

The retaining member 40 is integrally molded with a flexible material such as nylon resin or the like. As illustrated in FIG. 1, the retaining member 40 includes an annular portion 41 and a pair of leg portions 42, 42 extending from the annular portion 41. An outer diameter of the annular portion 41 is approximately equal to the inner diameter of the inner peripheral surface 26 of the joint body 20 while an inner diameter of the annular portion 41 is established to be approximately equal to the outer diameter of the tube 10. Each of the leg portions 42, 42, which exhibits a U-shaped cross-section, includes a projection 42a at an axially outer portion from the middle thereof and a notch 42b at an axially inner portion from the middle thereof.

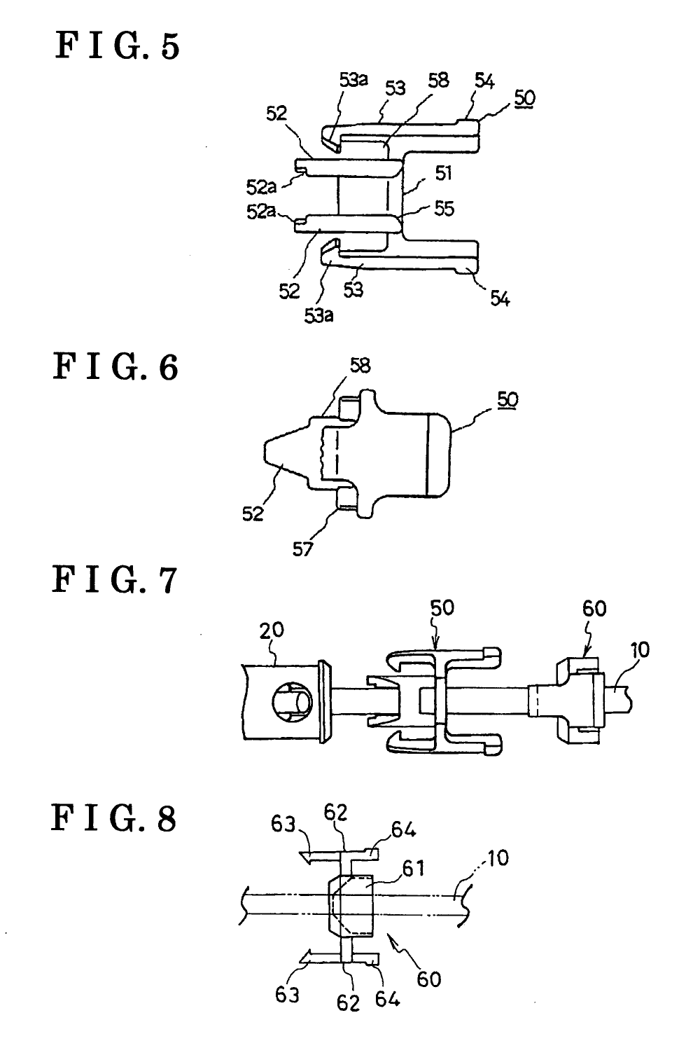

The guiding member 50 is also integrally molded with a flexible material such as nylon resin or the like. As illustrated in FIGS. 1 and 2 and FIGS. 4 to 6, the guiding member 50 includes an annular base 51, a pair of upper and lower arm portions 52, 52 extending forward (to the left side in FIG. 1 and other figures) from the base 51 as shown in FIG. 2 and FIGS. 4 and 5, a pair of upper and lower engagement portions 53, 53, an annular guiding portion 58, and a pair of upper and lower grips 54, 54 extending rearward (to the right side in FIG. 1) from the base 51.

The engagement portions 53, 53 respectively form projections 53a, 53a projecting inward from the ends of the engagement portions 53, 53. When the grips 54, 54 are pressed inward, the engagement portions 53, 53 are elastically deformed with respect to the annular guiding portion 58 (base 51) and the projections 53a, 53a are opened. When the above-mentioned pressing operation for the grips 54, 54 is released, the projections 53a, 53a are configured to return to original positions. Moreover, in the case of this pressing operation, in order to reduce an operating force and to improve attaching and detaching capabilities of the guiding member 50, the guiding member 50 is provided with a pair of upper and lower opening 56, 56 as shown in FIG. 4 so that resilience against deflection of the guiding member 50 is reduced. The opening 56, 56 are provided, so that water and dirt or the like intruded between the joint body 20 and the guiding member 50 easily fall down by providing the opening 56, 56. Furthermore, as shown in FIGS. 2 and 4, a pair of right and left seats 57, 57 are provided, thereby further improving the attaching and detaching capabilities of the guiding member 50. In other words, under the condition where the engagement portions 53, 53 and the grips 54, 54 are flexed by the above-mentioned pressing operation of the guiding member 50 on the basis of a supporting point of the base 51, the seats 57, 57 are provided, thereby locating the base 51 axially rearward (to the right side in FIG. 2). Accordingly, the distance between the base 51 serving as the supporting point of the pressing operation and the projections 53a, 53a serving as load centers are increased. Consequently, the projections 53a, 53a of the engagement portions 53, 53 open radially outwardly at a large opening amount in response to a pressing operation of the grips 54, 54, thereby improving the attaching and detaching of the guiding member 50.

Ends of the arm portions 52, 52 form tapered shapes gradually tapering towards the ends as shown in FIG. 6.

The annular guiding portion 58 includes an outer diameter approximately equal to an inner diameter 22 of the opening of the joint body 20 and an inner diameter approximately equal to the outer diameter of the tube 10.

Roundness 55 (circular shape) having a specified radius is provided at a rim of an opening of the base 51 at a rear surface of the base 51 (right side in FIG. 1).

Next, in the above-mentioned structure, a case for assembling the tube 10 to the joint body 20 will be explained.

First, the O-ring 30, the support ring 31, and the other O-ring 30 are pushed into the joint body 20 in the above-mentioned order, and then the annular portion 41 of the retaining member 40 is pushed into the joint body 20 in the same way. Next, the projections 42a, 42a of the leg portions 42, 42 of the retaining member 40, are respectively fitted into the corresponding pass-through windows 21, 21 of the joint body 20.

In such a condition, the end of the tube 10 is inserted into the base 51 of the guiding member 50, and the tube 10 is pushed through the opening of the joint body 20 toward the inside. In such a case, when the annular projection 12 formed on the tube 10 is fitted into the notches 42b, 42b of the leg portions 42, 42 formed on the retaining member 40 (in the condition of FIG. 1), assembling of the tube 10 to the joint body 20 is completed.

Next, the guiding member 50 is pushed through the opening of the joint body 20 toward the inside, and the projections 53a, 53a formed at the ends of the engagement portions 53, 53 are engaged with the flange 23 formed on the outer periphery of the opening edge of the joint body 20. In addition, the guiding member 50 may be mounted at the same time as the tube 10 is mounted as mentioned above. In this case, it is preferable that the guiding member 50 is assembled with the joint body 20 with ends of the arm portions 52, 52 of the guiding member 50 being in contact with the annular projections 12, thereby assembling the guiding member 50 and the tube 10 to the joint body 20.

When the guiding member 50 is completely mounted on the joint body 20, the annular guiding member 58 of the guiding member 50 is located internally in the opening of the joint body 20 (see FIG. 1), which the annular guiding portion 58 includes the outer diameter approximately equal to the inner diameter 22 of the opening of the joint body 20 and the inner diameter approximately equal to the outer diameter of the tube 10. Therefore, radial vibration of the tube 10 with respect to the joint body 20 is restrained, so that the tube 10 does not vibrate on the basis of ends of the leg portions 42, 42. Consequently, even when the tube 10 vibrates against the joint body 20, the leg portions 42, 42 of the retaining member 40 are not radially outwardly deflected since the outer peripheral surface of the tube 10 does not press the leg portions 42, 42 of the retaining member 40. Accordingly, even when the tube 10 continues vibrating in the radial direction relative to the joint body 20 for a long time, it may not occur that the leg portions 42, 42 of the retaining member 40, which is made of flexible material such as nylon resin or the like, do not restore to original shapes of the leg portions 42, 42 while being opened radially outwardly due to a creep phenomenon. Therefore, reliability against detachment of the tube 10 from the joint body 20 may be improved even under vehicle vibrations, increase in the inner pressure of the tube 10, or the like. Moreover, as described above, roundness 55 (circular shape) having a specified radius is provided at the rim of the opening of the base 51 at the rear surface of the base 51 (right side in FIG. 1). Therefore, although compressive concentrated stress is applied to a partial area of the pipe 10 in contact with the rim of the opening of the base 51 when the pipe 10 radially vibrates with respect to the joint body 20 on the basis of the rim serving as a supporting point, the roundness 55 formed at the rim of the opening of the base 51 reduces the amount of compressive concentrated stress acting on the partial area of the pipe 10. Hereby, durability and reliability of the tube 10 may be improved under external environments of vehicle vibrations or the like.

Furthermore, the piping joint according to the embodiment of the present invention includes a holder 60 as shown in FIG. 7. FIG. 7 is a view illustrating a positional relation between the holder 60 and the guiding member 50. The holder 60 is mounted on the guiding member 50 in order to prevent the guiding member 50 from being detached from the joint body 20.

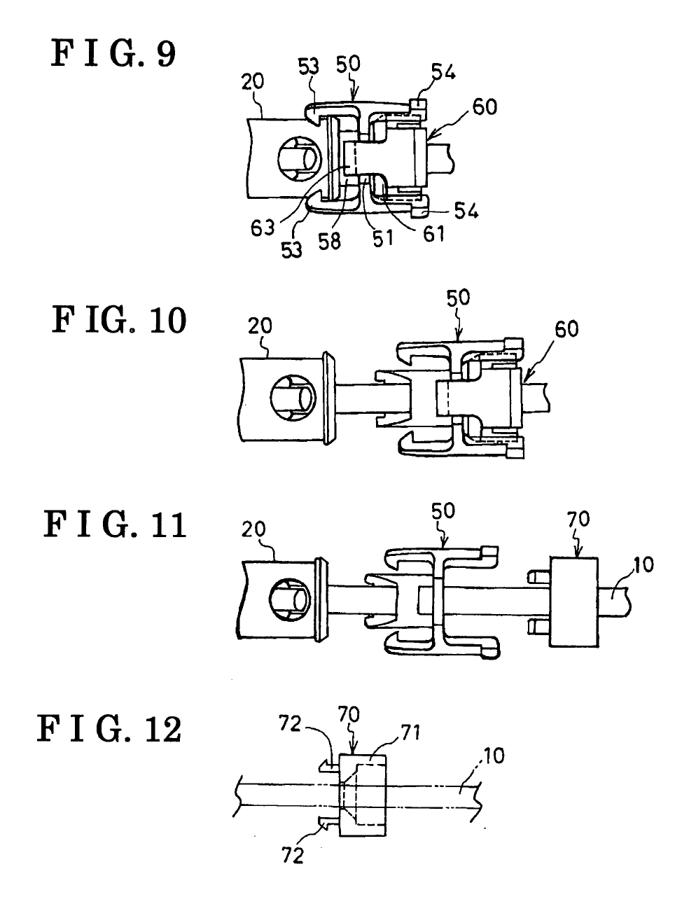

FIG. 8 is a top view of the holder 60 shown in FIG. 7. FIG. 9 shows illustrates a condition where the holder 60 is mounted on the guiding member 50. The holder 60 includes an annular base 61 and engagement portions 62, 62 which are integrally formed with the base 61 so as to be elastically deformable with respect to the base 61. The tube 10 is inserted into the base 61. Each engagement portion 62 is provided with a detent 63 and a grip 64. When the grips 64, 64 are pressed radially inward, the engagement portions 62, 62 are elastically deformed with respect to the annular base 61 and then the detents 63 are opened radially outward. When the pressed grips 64, 64 are released, the detents 63, 63 return to original positions.

In cases of mounting the holder 60 on the guiding member 50, after inserting the tube 10 into the base 61, the engagement portions 62, 62 are elastically deformed with respect to the base 61 and the detents 63, 63 are engaged with the base 51 of the guiding member 50. At this point, since the base 61 of the holder 60 is located radially inward of the grips 54, 54 of the guiding member 50 as shown in FIG. 9, the grips 54, 54 of the guiding member 50 are restrained from being pressed radially inward. In other words, in the guiding member 50, the engagement portions 53, 53 are restrained, by the base 61 of the holder 60, from being elastically deformed with respect to the annular guiding portion 58 (base 51). Hereby, the engagement portions 53, 53 of the guiding member 50 are not opened radially outward, thus preventing the guiding member 50 from being detached from the joint body 20.

In addition, as shown in FIG. 10, before mounting the guiding member 50 on the joint body 20, the holder 60 may be mounted on the guiding member 50 in advance. In this way, the guiding member 50 integrated with the holder 60 may be mounted on the joint body 20.

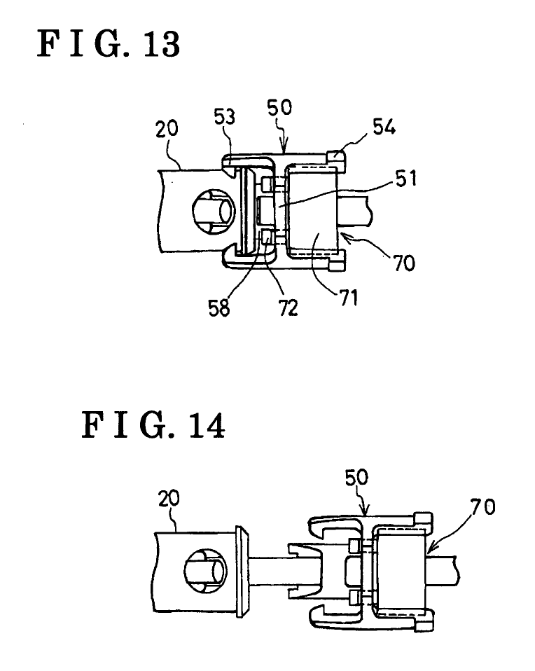

FIG. 11 is a view illustrating another embodiment of the holder 60 (relating to a holder 70) and a positional relation between the holder 70 and the guiding member 50. FIG. 12 illustrates a top view of the holder 70 shown in FIG. 11. FIG. 13 illustrates a condition where the holder 70 is mounted on the guiding member 50.

The holder 70 includes an annular base 71 and engagement portions 72, 72 which are integrally formed with the annular base 71 so as to be elastically deformable with respect to the base 71. In case of mounting the holder 70 on the guiding member 50, after inserting the tube 10 into the base 71, the engagement portions 72, 72 are elastically deformed with respect to the base 71 and are engaged with the base 51 of the guiding member 50. At this point, since the base 71 of the holder 70 is located radially inward of the grips 54, 54 of the guiding member 50 as shown in FIG. 13, the grips 54, 54 of the guiding member 50 are restrained from being pressed radially inward. In other words, in the guiding member 50, the engagement portions 53, 53 are restrained, by the base 71 of the holder 70, from being elastically deformed with respect to the annular guiding portion 58 (base 51). Hereby, the engagement portions 53, 53 of the guiding member 50 are not opened radially outward, thus preventing the guiding member 50 from being detached from the joint body 20.

In addition, as shown in FIG. 14, before mounting the guiding member 50 on the joint body 20, the holder 70 is mounted on the guiding member 50 in advance. In this way, the guiding member 50 integrated with the holder 70 may be mounted on the joint body 20.

As explained above, the piping joint according to the embodiment of the present invention includes the guiding member 50. The guiding member 50 includes the annular guiding portion 58 inserted into the opening of the joint body 20, arranged between the inner peripheral surface of the joint body 20 and the outer peripheral surface of the tube 10, and guiding the tube 10 so as to prevent the tube 10 from vibrating in a radial direction of the joint body 20. The guiding member 50 further includes the engagement portions 53, 53 elastically deformable with respect to the annular guide potion 58 and engageable with the outer peripheral surface of the joint body 20. The guiding member 50 is detached from the joint body 20 when the engagement portions 53, 53 are elastically deformed with respect to the annular guiding portion 58. The joint body 20 also includes the holder 60 (holder 70) for restraining the engagement portions 53, 53 from being elastically deformed with respect to the annular guiding portion 58. According to this structure, the holder 60 (holder 70) restrains the engagement portions 53, 53 of the guiding member 50 from being elastically deformed with respect to the annular guiding portion 58. Therefore, the guiding member 50 is not detached from the joint body 20, so that the guiding member 50 restrains the tube 10 from vibrating with respect to the retaining member 40. Hereby, the tube 10 is surely prevented from being pulled out of the retaining member 40, thereby further improving the reliability relating to the connection between the joint body 20 and the tube 10.

Especially, in environments where the joint body 20 widely moves with respect to the tube 10 (in the portion where the tube 10 is connected and supported), when the guiding member 50 is detached from the joint body 20 from any cause, a large force is applied between the tube 10 and the retaining member 40. Therefore, load, which may drop the tube 10 from the retaining member 40, may decrease. Under such environments, the structure according to the embodiment of the present invention is especially effective to adequately obtain the reliability related to the connection between the joint body 20 and the tube 10.

According to the above-described structure, elastic deformation of the engagement portions relative to the guiding portion of the guiding member is restrained by the restraining member. Therefore, the guiding member is not detached from the joint body and vibrations of the tube relative to the retaining member are restrained by the retaining member. Therefore, it is possible to ensure the function of the guiding member and to enhance a reliability in connection between the joint body and the tube.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A piping joint comprising:
a joint body being a hollow shape and formed with a passage;
a tube inserted into the joint body through the passage;
a retaining member mounted inside the joint body and located at a distance from an opening of the joint body, the retaining member supporting the tube inserted into the joint body;
a guiding member having a guiding portion and engagement portions, the guiding portion inserted into the joint body through the opening and arranged between an inner peripheral surface of the joint body and an outer peripheral surface of the tube, the guiding portion guiding the tube so as to prevent the tube from vibrating in a radial direction of the joint body, the engagement portions elastically deformable relative to the guiding portion and engageable with an outer peripheral surface of the joint member, wherein the guiding member is detached from the joint body when the engagement portions are elastically deformed with respect to the guiding portion; and
a restraining member mounted to the guiding member and restraining an elastic deformation of the engagement portions relative to the guiding portion.

2. The piping joint according to Clam 1, wherein the guiding member further includes a base, and the restraining member includes a restraining base and restraining engagement portions engageable with the base of the guiding member, wherein the restraining member is engaged with the guiding member via the restraining engagement portions engaged with the base of the guiding member.

3. The piping joint according to claim 1, wherein the guiding member and the restraining member are arranged coaxially with each other.

4. The piping joint according to claim 2, wherein the restraining engagement portions are elastically deflected relative to the restraining base so as to be engaged with the base of the guiding member.

5. The piping joint according to claim 2, wherein the restraining base are integrally formed with the restraining engagement portions.

6. The piping joint according to claim 2, wherein the restraining base is an annular shape.
